(19) United States
(12) Patent Application Publication
(10) Pub. No.: US 2016/0239299 A1
(43) Pub. Date: Aug. 18, 2016

(54) SYSTEM, APPARATUS, AND METHOD FOR IMPROVED EFFICIENCY OF EXECUTION IN SIGNAL PROCESSING ALGORITHMS

(71) Applicant: Intel Corporation, Santa Clara, CA (US)

(72) Inventors: Chetan D. Hiremath, Portland, OR (US); Udayan Murkherjee, Portland, OR (US)

(73) Assignee: Intel Corporation, Santa Clara, CA (US)

(21) Appl. No.: 15/139,284

(22) Filed: Apr. 26, 2016

Related U.S. Application Data
(63) Continuation of application No. 12/976,951, filed on Dec. 22, 2010, now abandoned.

(51) Int. Cl. G06F 9/30; G06F 9/38

(52) U.S. Cl. CPC G06F 9/3001; G06F 9/3802; G06F 9/3016; G06F 9/30036

(57) ABSTRACT

Embodiments of methods, apparatuses, and machine-readable mediums for performing a bit reversal instruction in a computer processor are described. In some embodiments, the execution of such instruction causes the bit ordering for a source operand to be reversed and stored.

### FIELD OF INVENTION

The field of invention relates generally to computer processor architecture, and, more specifically, to instructions which when executed cause a particular result.

### BACKGROUND

Performance/latency requirements in the required power footprints for many existing and future workloads (4G+/LTE wireless infrastructure/baseband processing; medical (e.g. ultrasound), and military/aerospace applications (e.g. radar) are hard to achieve using current instruction sets. Many of the operations that are performed require multiple instructions in a specific order.

### BRIEF DESCRIPTION OF THE DRAWINGS

The present invention is illustrated by way of example and not limitation in the figures of the accompanying drawings, in which like references indicate similar elements and in which:

FIG. 1 depicts an embodiment of a method of complex multiplication through the execution of a CPLXMUL instruction with non-packed data operands.

An embodiment of the specifics of how these components are generated is illustrated in FIG. 2.

An example of packed data complex multiplication of two complex packed data X and Y is illustrated in FIG. 3.

FIG. 4 illustrates an exemplary pseudo-code embodiment of the method of execution of packed data complex multiplication instruction.

FIG. 5 illustrates an embodiment of a method for performing bit reverse on non-packed data in a processor using a bit reverse instruction.

FIG. 6 illustrates an embodiment of a method for performing bit reverse on packed data operands in a processor using a bit reverse instruction.

Examples of packed data bit reversal and byte bit reversal are illustrated in FIG. 7.

FIG. 8 illustrates an exemplary pseudo-code embodiment of the method of execution of packed data bit reverse instruction.

FIG. 9 is a block diagram illustrating an exemplary out-of-order architecture of a core according to embodiments of the invention.

FIG. 10 shows a block diagram of a system in accordance with one embodiment of the present invention.

FIG. 11 shows a block diagram of a second system in accordance with an embodiment of the present invention.

FIG. 12 shows a block diagram of a third system in accordance with an embodiment of the present invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

### Complex Multiplication

A typical signal processing workload is dominated by signals that are represented as complex numbers (i.e., having a real and imaginary component). Signal processing algorithms typically work on these complex numbers and perform operations such as addition, multiplication, subtraction, etc. The following description details embodiments of systems, apparatuses, and methods for performing multiplication on complex numbers or “complex multiplication.” Complex multiplication is a fundamental operation in most signal processing applications. An example of complex multiplication of the variables X=a+ib and Y=c+id is XY=(ac−bd)+i(ad+bc). In current architectures, to do this complex multiplication requires calling several different instructions in a specific sequence. This task may require even more operations for packed data operands.

Embodiments of a complex multiplication (CPLXMUL) instruction are detailed below as are embodiments of systems, architectures, instruction formats etc. that may be used to execute such instructions. When executed, a single CPLXMUL instruction causes a processor to multiply data elements of complex data source operands and store the result of those multiplications into a complex data destination.

In example of such an instruction is “CPLXMULW src1, src2, dst,” where “src1” is a first complex data source operand, “src2” is a second complex data source operand, and “dst” is a data destination operand. The data sources may be 16-bit signed word integers, single precision floating point values (32-bit), double precision floating point values (64-bit), quadruple floating point values (128-bit) and half precision floating point values (16-bit), etc. The source and destination operands may be memory or register locations. In some embodiments, when a source is a memory location, the data from that memory location is first stored into a register prior to any complex multiplication.

In some embodiments, the complex multiplication instruction operates on packed data operands. The number of data elements of the packed data operands to be operated on is dependent on data type and packed data width. Table 1 below shows an exemplary breakdown of the number of data elements by data type for a particular packed data size, however, it should be understood that different data types and packed data widths may also be used. For example, packed data widths of 128, 256, 512, 1024 bits, etc. may be used in some embodiments.

TABLE 1

| Data type | Packed data width (bits) | Number of elements |
|---|---|---|
| 16-bit signed integer | 128 | 8 |
| | 256 | 16 |
| | 512 | 32 |
| 16-bit half precision | 128 | 8 |
| floating point | 256 | 16 |
| | 512 | 32 |
| 32-bit single precision | 128 | 4 |
| | 256 | 8 |
| | 512 | 16 |
| 64-bit double precision | 128 | 2 |
| | 256 | 4 |
| | 512 | 8 |

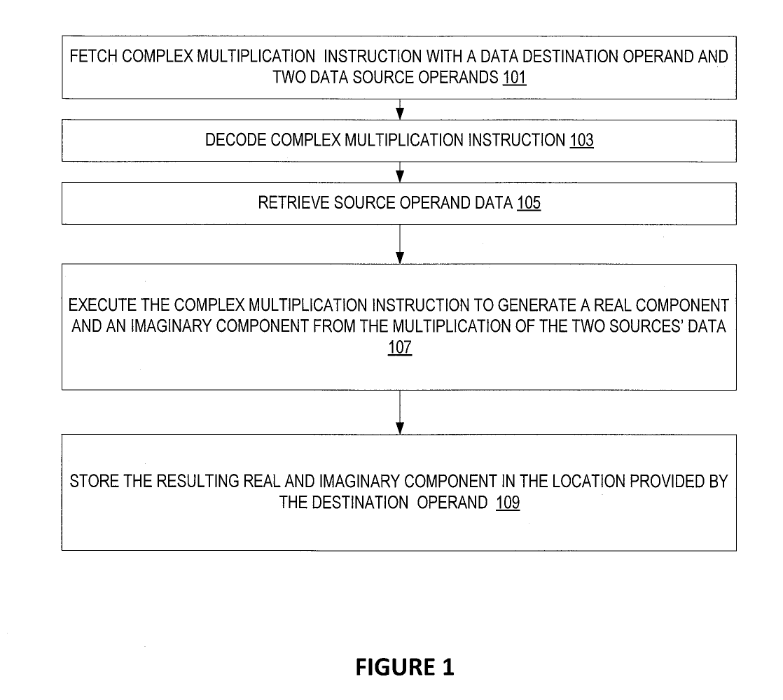

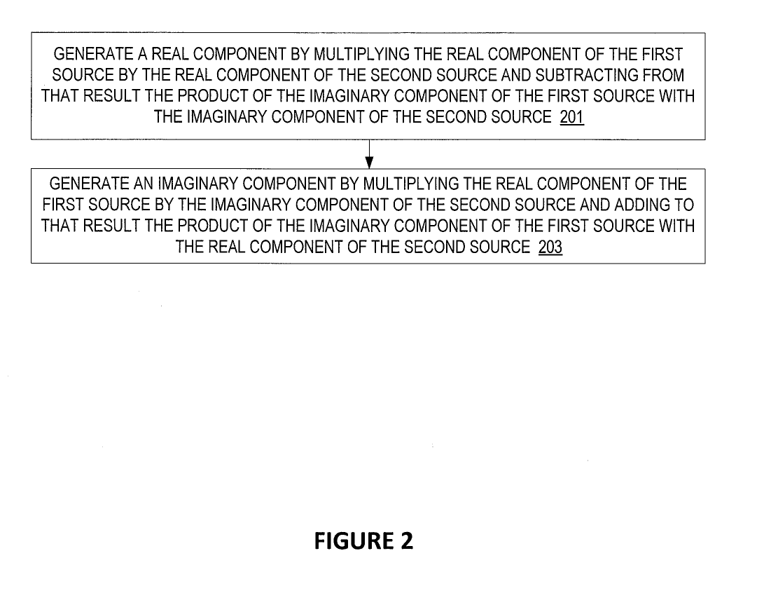

FIG. 1 depicts an embodiment of a method of complex multiplication through the execution of a CPLXMUL instruction with non-packed data operands. A complex data multiplication instruction data with a data destination operand and two complex data source operands is fetched at 101. Typically, this instruction is fetched from a L1 instruction cache inside of the processor.

The CPLXMUL instruction is decoded by a decoder at 103. The decoder includes logic to distinguish this instruction from other instructions. In some embodiments, the decoder may also utilize microcode to transform this instruction into micro-operations to be performed by the function/execution units of the processor.

The source operand values are retrieved at 105. If both sources are registers then the data from those registers is retrieved. If one or more of the sources operands is a memory location, the data from memory location is retrieved. In some embodiments, this data resides in the cache of the core. As detailed earlier, this typically entails placing the data from the memory into a register prior to any execution by a function/execution unit, however, that is not the case for all embodiments. In some embodiments, the data is simply pulled from memory and used in the execution of the instruction.

The CPLXMUL instruction is executed by one or more function/execution units at 107 to generate a real and an imaginary component resulting from the multiplication of the source operands. An embodiment of the specifics of how these components are generated is illustrated in FIG. 2.

As shown in FIG. 2, the real component is generated by multiplying the real component of the first source by the real component of the second source and subtracting from that result the product of the imaginary component of the first source with the imaginary component of the second source at 201. Shown mathematically, this is (source 1 real component*source 2 real component)−(source 1 imaginary component*source 2 imaginary component). In terms of X and Y shown above it is ac−bd.

The imaginary component is generated by multiplying the real component of the first source by the imaginary component of the second source and adding to that result the product of the imaginary component of the first source with the real component of the second source at 203. Shown mathematically, this is (source 1 real component*source 2 imaginary component)−(source 1 imaginary component*source 2 real component). In terms of X and Y shown above it is ad+bc.

While the generation of these components is illustrated in one order they may be generated in parallel or in the opposite order.

The particular function/execution unit used may be dependent on the data type. For example, if the data is floating point, then a floating point function/execution unit(s) is used. Similarly, if the data is in integer format, then an integer function/execution unit(s) is used. Integer operations may also require saturation and/or rounding to place the resulting data into an acceptable form.

The generated real and imaginary components are stored in the destination location (register or memory location) at 109.

Figure HHH depicts an exemplary execution of a CPLXMUL instruction with packed data operands. For the most part this is very similar to the execution of such an instruction without packed data operands. The most significant deviation is that there is a generation of real and imaginary components on a data element by data element basis in HHH07. For example, data element 0 of source 1 is complex multiplied by data element 0 of source 2. The results of this complex multiplication are stored in data element position 0 of the destination.

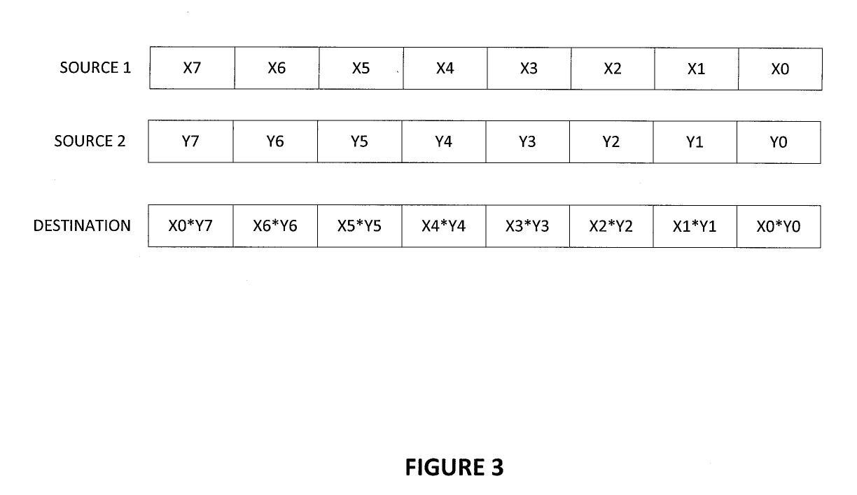

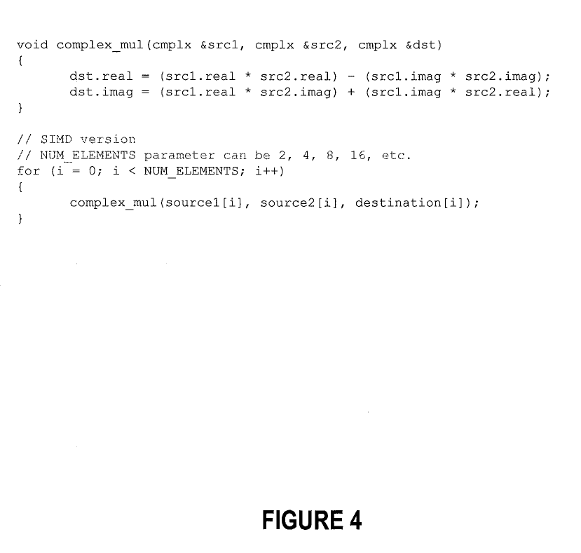

An example of packed data complex multiplication of two complex packed data X and Y is illustrated in FIG. 3. X and Y are complex numbers. FIG. 4 illustrates an exemplary pseudo-code embodiment of the method of execution of packed data complex multiplication instruction.

The embodiments above detail a single atomic operation for complex multiplication. This removes the need for a particular sequence of instructions and thereby increases the performance of signal processing applications in embedded, HPC, and TPT usage by way of example including those detailed above.

### Bit Reversal

Fourier Transforms are fundamental to signal processing. In some situations, the Fourier Transform requires that one or more of the outputs are written to locations whose indexes are bit reversed relative to their input indexes.

In example of such an instruction is “BITRB src, dst,” where “src” is a data source operand and “dst” is a data destination operand. The data source may be 8-bit unsigned bytes, 16-bit word integers, 32-bit double word, etc. The source and destination operands may be memory or register locations. In some embodiments, when a source is a memory location, the data from that memory location is first stored into a register prior to any bit reversal. Additionally, in some embodiments, the source is a packed data operand with data elements of the sizes detailed earlier.

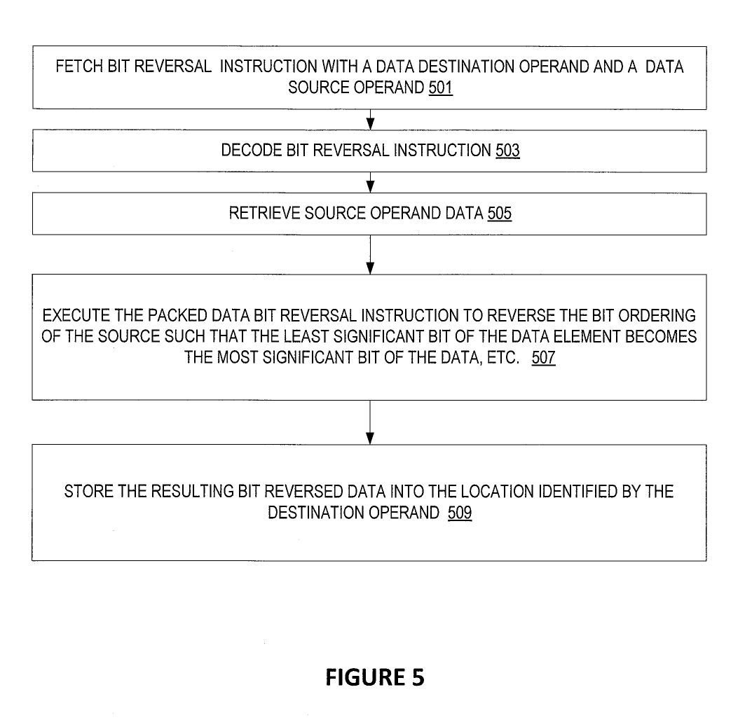

FIG. 5 illustrates an embodiment of a method for performing bit reverse on non-packed data in a processor using a bit reverse instruction.

A bit reverse with a data destination operand and an unsigned data source operand is fetched at 501. Typically, this instruction is fetched from a L1 instruction cache inside of the processor.

The bit reverse instruction is decoded by a decoder at 503. The decoder includes logic to distinguish this instruction from other instructions. In some embodiments, the decoder may also utilize microcode to transform this instruction into micro-operations to be performed by the function/execution units of the processor.

The source operand values are retrieved at 505. If the source is a register then the data from that register is retrieved. If the source is a memory location, the data from memory location is retrieved. As detailed earlier, this typically entails placing the data from the memory into a register prior to any execution by a function/execution unit, however, that is not the case for all embodiments. In some embodiments, the data is simply pulled from memory and used in the execution of the instruction.

The bit reverse instruction is executed at 507 by one or more function/execution units to reverse the bit ordering of the source such that the least significant bit of the source becomes the most significant bit, the second-most least significant bit becomes the second-most significant bit, etc.

The bit reversed data is stored into the destination at 509.

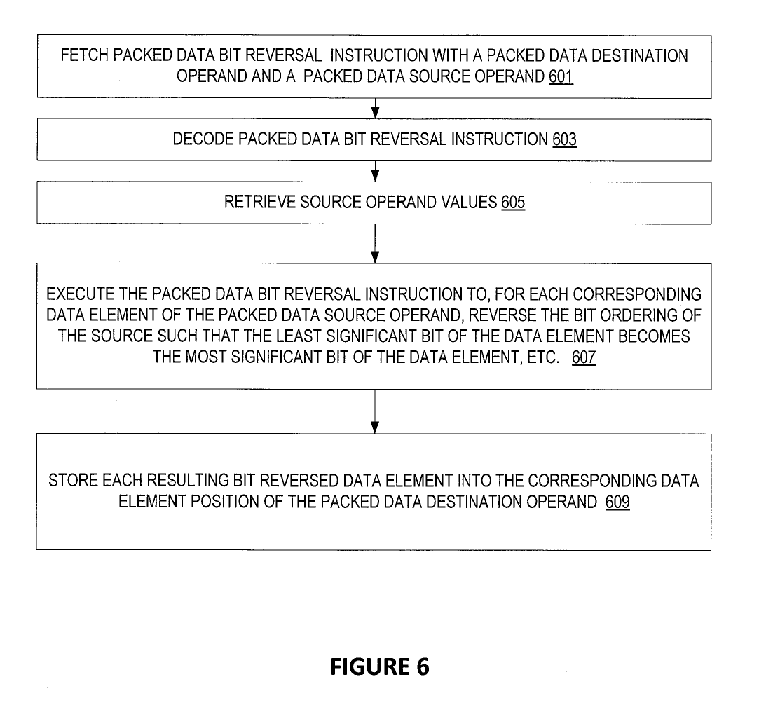

FIG. 6 illustrates an embodiment of a method for performing bit reverse on packed data operands in a processor using a bit reverse instruction.

A bit reverse with a data destination operand and an unsigned, packed data source operand is fetched at 601. Typically, this instruction is fetched from a L1 instruction cache inside of the processor.

The bit reverse instruction is decoded by a decoder at 603. The decoder includes logic to distinguish this instruction from other instructions. In some embodiments, the decoder may also utilize microcode to transform this instruction into micro-operations to be performed by the function/execution units of the processor.

The source operand values are retrieved at 605. If the source is a register then the data from that register is retrieved. If the source is a memory location, the data from memory location is retrieved. As detailed earlier, this typically entails placing the data from the memory into a register prior to any execution by a function/execution unit, however, that is not the case for all embodiments. In some embodiments, the data is simply pulled from memory and used in the execution of the instruction.

The bit reverse instruction is executed at 607 by one or more function/execution units to, for each corresponding data element of the packed data source operand, reverse the bit ordering of the data element such that the least significant bit of the data element becomes the most significant bit, the second-most least significant bit becomes the second-most significant bit, etc. The reversal of each data element may be done in parallel or serially. The number of data elements is dependent on the packed data width and data type as shown in Table 1 and discussed earlier.

The bit reversed data elements are stored into the destination at 609.

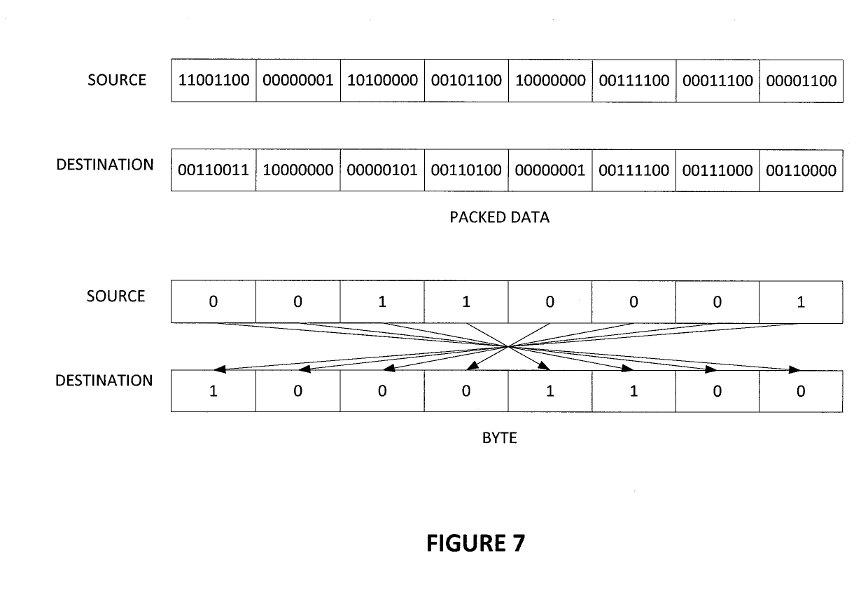

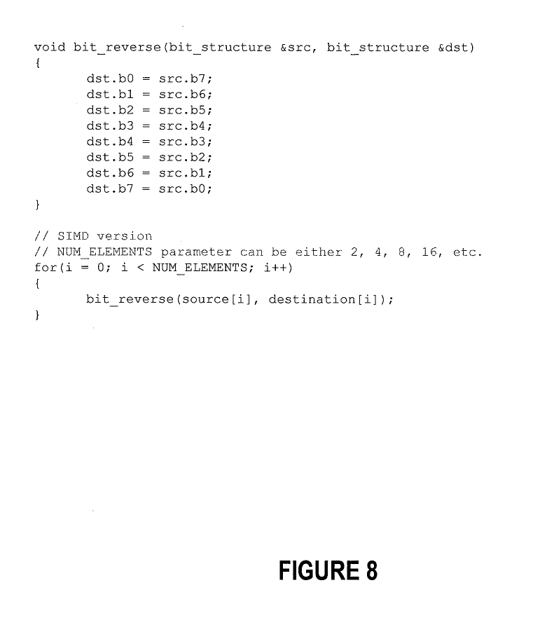

Examples of packed data bit reversal and byte bit reversal are illustrated in FIG. 7. FIG. 8 illustrates an exemplary pseudo-code embodiment of the method of execution of packed data bit reverse instruction.

### Exemplary Computer Systems and Processors

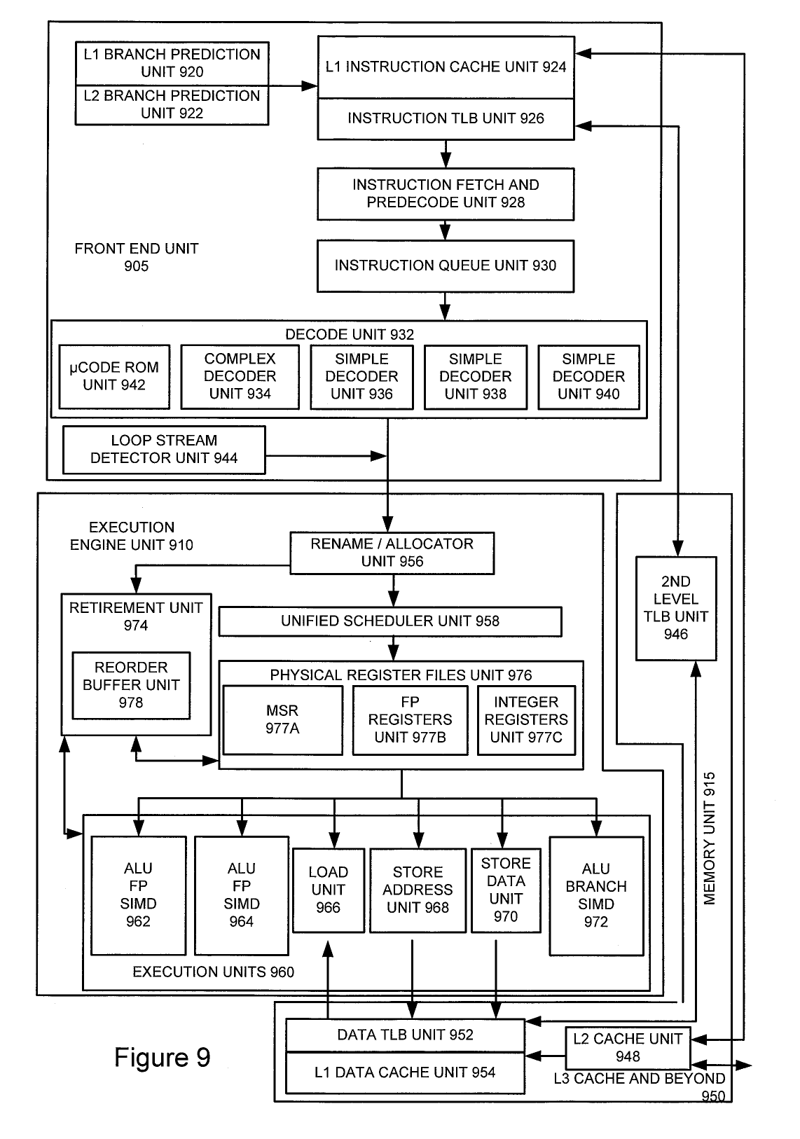

Embodiments of apparatuses and systems capable of executing the above instructions are detailed below. FIG. 9 is a block diagram illustrating an exemplary out-of-order architecture of a core according to embodiments of the invention. However, the instructions described above may be implemented in an in-order architecture too. In FIG. 9, arrows denote a coupling between two or more units and the direction of the arrow indicates a direction of data flow between those units. Components of this architecture may be used to process the instructions detailed above including the fetching, decoding, and execution of these instructions.

FIG. 9 includes a front end unit 905 coupled to an execution engine unit 910 and a memory unit 915; the execution engine unit 910 is further coupled to the memory unit 915.

The front end unit 905 includes a level 1 (L1) branch prediction unit 920 coupled to a level 2 (L2) branch prediction unit 922. These units allow a core to fetch and execute instructions without waiting for a branch to be resolved. The L1 and L2 brand prediction units 920 and 922 are coupled to an L1 instruction cache unit 924. L1 instruction cache unit 924 holds instructions or one or more threads to be potentially be executed by the execution engine unit 910.

The L1 instruction cache unit 924 is coupled to an instruction translation lookaside buffer (ITLB) 926. The ITLB 926 is coupled to an instruction fetch and predecode unit 928 which splits the bytestream into discrete instructions.

The instruction fetch and predecode unit 928 is coupled to an instruction queue unit 930 to store these instructions. A decode unit 932 decodes the queued instructions including the instructions described above. In some embodiments, the decode unit 932 comprises a complex decoder unit 934 and three simple decoder units 936, 938, and 940. A simple decoder can handle most, if not all, x86 instruction which decodes into a single uop. The complex decoder can decode instructions which map to multiple uops. The decode unit 932 may also include a micro-code ROM unit 942.

The L1 instruction cache unit 924 is further coupled to an L2 cache unit 948 in the memory unit 915. The instruction TLB unit 926 is further coupled to a second level TLB unit 946 in the memory unit 915. The decode unit 932, the micro-code ROM unit 942, and a loop stream detector (LSD) unit 944 are each coupled to a rename/allocator unit 956 in the execution engine unit 910. The LSD unit 944 detects when a loop in software is executed, stop predicting branches (and potentially incorrectly predicting the last branch of the loop), and stream instructions out of it. In some embodiments, the LSD 944 caches micro-ops.

The execution engine unit 910 includes the rename/allocator unit 956 that is coupled to a retirement unit 974 and a unified scheduler unit 958. The rename/allocator unit 956 determines the resources required prior to any register renaming and assigns available resources for execution. This unit also renames logical registers to the physical registers of the physical register file.

The retirement unit 974 is further coupled to execution units 960 and includes a reorder buffer unit 978. This unit retires instructions after their completion.

The unified scheduler unit 958 is further coupled to a physical register files unit 976 which is coupled to the execution units 960. This scheduler is shared between different threads that are running on the processor.

The physical register files unit 976 comprises a MSR unit 977A, a floating point registers unit 977B, and an integers registers unit 977C and may include additional register files not shown (e.g., the scalar floating point stack register file 545 aliased on the MMX packed integer flat register file 550).

The execution units 960 include three mixed scalar and SIMD execution units 962, 964, and 972; a load unit 966; a store address unit 968; a store data unit 970. The load unit 966, the store address unit 968, and the store data unit 970 perform load/store and memory operations and are each coupled further to a data TLB unit 952 in the memory unit 915.

The memory unit 915 includes the second level TLB unit 946 which is coupled to the data TLB unit 952. The data TLB unit 952 is coupled to an L1 data cache unit 954. The L1 data cache unit 954 is further coupled to an L2 cache unit 948. In some embodiments, the L2 cache unit 948 is further coupled to L3 and higher cache units 950 inside and/or outside of the memory unit 915.

The following are exemplary systems suitable for executing the instruction(s) detailed herein. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

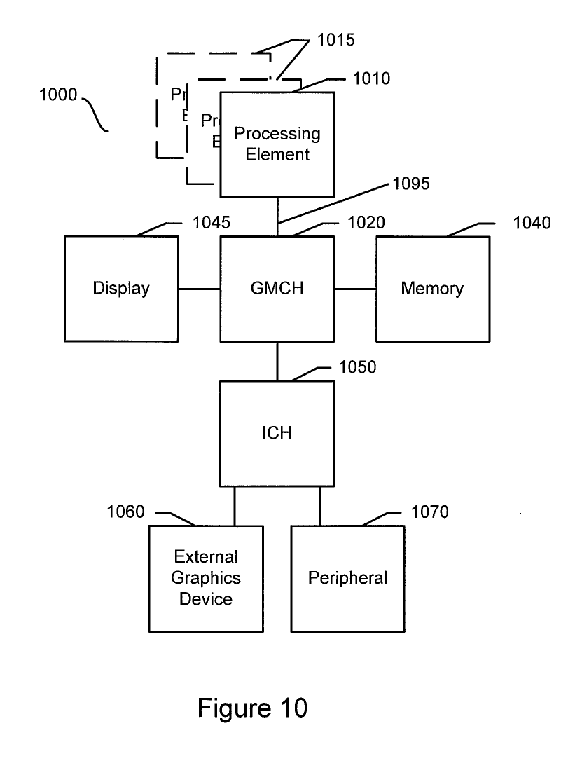

Referring now to FIG. 10, shown is a block diagram of a system 1000 in accordance with one embodiment of the present invention. The system 1000 may include one or more processing elements 1010, 1015, which are coupled to graphics memory controller hub (GMCH) 1020. The optional nature of additional processing elements 1015 is denoted in FIG. 10 with broken lines.

Each processing element may be a single core or may, alternatively, include multiple cores. The processing elements may, optionally, include other on-die elements besides processing cores, such as integrated memory controller and/or integrated I/O control logic. Also, for at least one embodiment, the core(s) of the processing elements may be multithreaded in that they may include more than one hardware thread context per core.

FIG. 10 illustrates that the GMCH 1020 may be coupled to a memory 1040 that may be, for example, a dynamic random access memory (DRAM). The DRAM may, for at least one embodiment, be associated with a non-volatile cache.

The GMCH 1020 may be a chipset, or a portion of a chipset. The GMCH 1020 may communicate with the processor(s) 1010, 1015 and control interaction between the processor(s) 1010, 1015 and memory 1040. The GMCH 1020 may also act as an accelerated bus interface between the processor(s) 1010, 1015 and other elements of the system 1000. For at least one embodiment, the GMCH 1020 communicates with the processor(s) 1010, 1015 via a multi-drop bus, such as a frontside bus (FSB) 1095.

Furthermore, GMCH 1020 is coupled to a display 1045 (such as a flat panel display). GMCH 1020 may include an integrated graphics accelerator. GMCH 1020 is further coupled to an input/output (I/O) controller hub (ICH) 1050, which may be used to couple various peripheral devices to system 1000. Shown for example in the embodiment of FIG. 10 is an external graphics device 1060, which may be a discrete graphics device coupled to ICH 1050, along with another peripheral device 1070.

Alternatively, additional or different processing elements may also be present in the system 1000. For example, additional processing element(s) 1015 may include additional processors(s) that are the same as processor 1010, additional processor(s) that are heterogeneous or asymmetric to processor 1010, accelerators (such as, e.g., graphics accelerators or digital signal processing (DSP) units), field programmable gate arrays, or any other processing element. There can be a variety of differences between the physical resources 1010, 1015 in terms of a spectrum of metrics of merit including architectural, microarchitectural, thermal, power consumption characteristics, and the like. These differences may effectively manifest themselves as asymmetry and heterogeneity amongst the processing elements 1010, 1015. For at least one embodiment, the various processing elements 1010, 1015 may reside in the same die package.

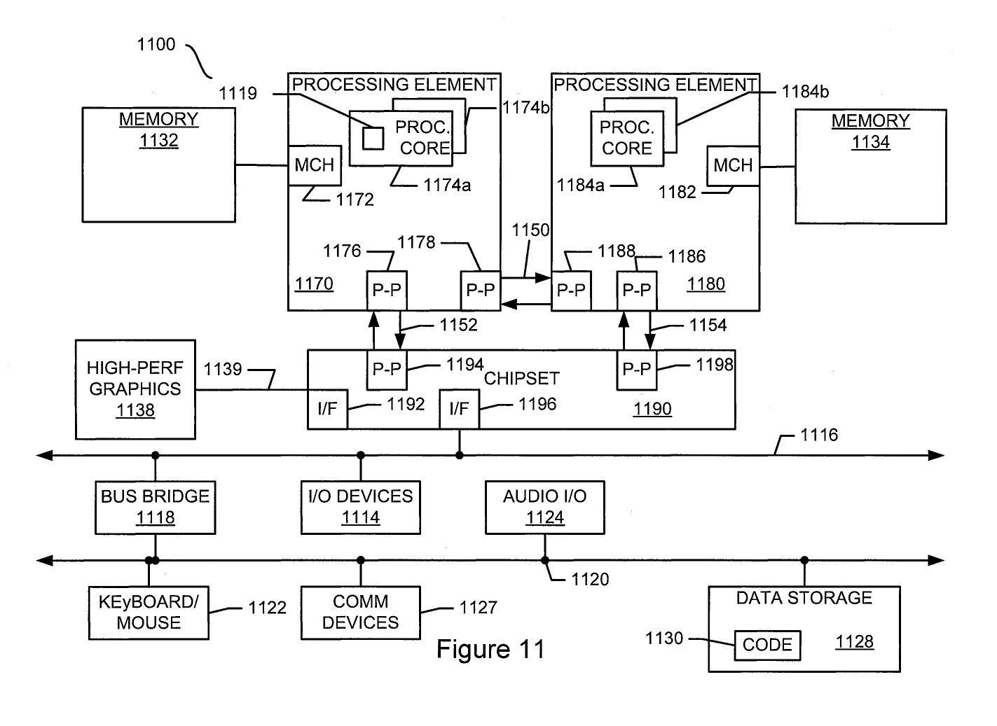

Referring now to FIG. 11, shown is a block diagram of a second system 1100 in accordance with an embodiment of the present invention. As shown in FIG. 11, multiprocessor system 1100 is a point-to-point interconnect system, and includes a first processing element 1170 and a second processing element 1180 coupled via a point-to-point interconnect 1150. As shown in FIG. 11, each of processing elements 1170 and 1180 may be multicore processors, including first and second processor cores (i.e., processor cores 1174a and 1174b and processor cores 1184a and 1184b).

Alternatively, one or more of processing elements 1170, 1180 may be an element other than a processor, such as an accelerator or a field programmable gate array.

While shown with only two processing elements 1170, 1180, it is to be understood that the scope of the present invention is not so limited. In other embodiments, one or more additional processing elements may be present in a given processor.

First processing element 1170 may further include a memory controller hub (MCH) 1172 and point-to-point (P-P) interfaces 1176 and 1178. Similarly, second processing element 1180 may include a MCH 1182 and P-P interfaces 1186 and 1188. Processors 1170, 1180 may exchange data via a point-to-point (PtP) interface 1150 using PtP interface circuits 1178, 1188. As shown in FIG. 11, MCH's 1172 and 1182 couple the processors to respective memories, namely a memory 1142 and a memory 1144, which may be portions of main memory locally attached to the respective processors.

Processors 1170, 1180 may each exchange data with a chipset 1190 via individual PtP interfaces 1152, 1154 using point to point interface circuits 1176, 1194, 1186, 1198. Chipset 1190 may also exchange data with a high-performance graphics circuit 1138 via a high-performance graphics interface 1139. Embodiments of the invention may be located within any processor having any number of processing cores, or within each of the PtP bus agents of FIG. 11. In one embodiment, any processor core may include or otherwise be associated with a local cache memory (not shown). Furthermore, a shared cache (not shown) may be included in either processor outside of both processors, yet connected with the processors via p2p interconnect, such that either or both processors' local cache information may be stored in the shared cache if a processor is placed into a low power mode.

First processing element 1170 and second processing element 1180 may be coupled to a chipset 1190 via P-P interconnects 1176, 1186 and 1184, respectively. As shown in FIG. 11, chipset 1190 includes P-P interfaces 1194 and 1198. Furthermore, chipset 1190 includes an interface 1192 to couple chipset 1190 with a high performance graphics engine 1148. In one embodiment, bus 1149 may be used to couple graphics engine 1148 to chipset 1190. Alternately, a point-to-point interconnect 1149 may couple these components.

In turn, chipset 1190 may be coupled to a first bus 1116 via an interface 1196. In one embodiment, first bus 1116 may be a Peripheral Component Interconnect (PCI) bus, or a bus such as a PCI Express bus or another third generation I/O interconnect bus, although the scope of the present invention is not so limited.

As shown in FIG. 11, various I/O devices 1114 may be coupled to first bus 1116, along with a bus bridge 1118 which couples first bus 1116 to a second bus 1120. In one embodiment, second bus 1120 may be a low pin count (LPC) bus. Various devices may be coupled to second bus 1120 including, for example, a keyboard/mouse 1122, communication devices 1126 and a data storage unit 1128 such as a disk drive or other mass storage device which may include code 1130, in one embodiment. Further, an audio I/O 1124 may be coupled to second bus 1120. Note that other architectures are possible. For example, instead of the point-to-point architecture of FIG. 11, a system may implement a multi-drop bus or other such architecture.

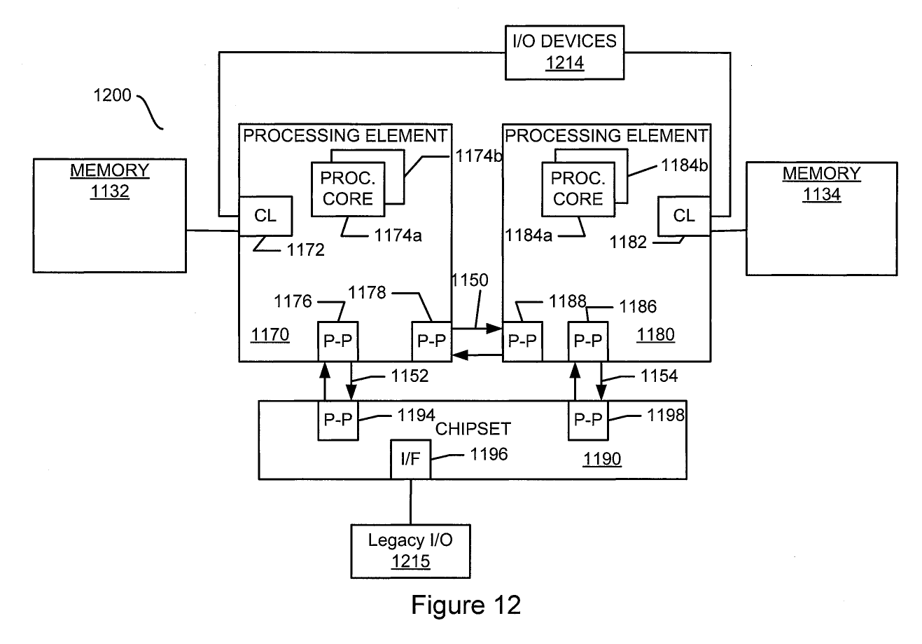

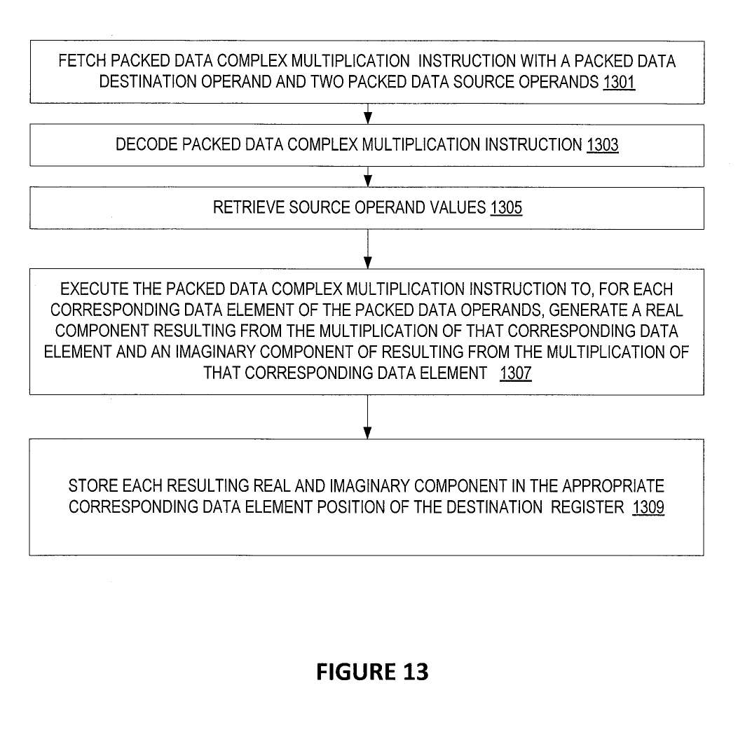

Referring now to FIG. 12, shown is a block diagram of a third system 1200 in accordance with an embodiment of the present invention. Like elements in FIGS. 11 and 12 bear like reference numerals, and certain aspects of FIG. 11 have been omitted from FIG. 12 in order to avoid obscuring other aspects of FIG. 12.

FIG. 12 illustrates that the processing elements 1170, 1180 may include integrated memory and I/O control logic (“CL”) 1172 and 1182, respectively. For at least one embodiment, the CL 1172, 1182 may include memory controller hub logic (MCH) such as that described above in connection with FIGS. 10 and 11. In addition. CL 1172, 1182 may also include I/O control logic. FIG. 12 illustrates that not only are the memories 1142, 1144 coupled to the CL 1172, 1182, but also that I/O devices 1214 are also coupled to the control logic 1172, 1182. Legacy I/O devices 1215 are coupled to the chipset 1190.

Embodiments of the mechanisms disclosed herein may be implemented in hardware, software, firmware, or a combination of such implementation approaches. Embodiments of the invention may be implemented as computer programs or program code executing on programmable systems comprising at least one processor, a data storage system (including volatile and non-volatile memory and/or storage elements), at least one input device, and at least one output device.

Program code, such as code 1130 illustrated in FIG. 11, may be applied to input data to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative data stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of particles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMS) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

Accordingly, embodiments of the invention also include non-transitory, tangible machine-readable media containing instructions or containing design data, such as HDL, which defines structures, circuits, apparatuses, processors and/or system features described herein. Such embodiments may also be referred to as program products.

Certain operations of the instruction(s) disclosed herein may be performed by hardware components and may be embodied in machine-executable instructions that are used to cause, or at least result in, a circuit or other hardware component programmed with the instructions performing the operations. The circuit may include a general-purpose or special-purpose processor, or logic circuit, to name just a few examples. The operations may also optionally be performed by a combination of hardware and software. Execution logic and/or a processor may include specific or particular circuitry or other logic responsive to a machine instruction or one or more control signals derived from the machine instruction to store an instruction specified result operand. For example, embodiments of the instruction(s) disclosed herein may be executed in one or more the systems of FIGS. 10, 11, and 12 and embodiments of the instruction(s) may be stored in program code to be executed in the systems.

The above description is intended to illustrate preferred embodiments of the present invention. From the discussion above it should also be apparent that especially in such an area of technology, where growth is fast and further advancements are not easily foreseen, the invention can may be modified in arrangement and detail by those skilled in the art without departing from the principles of the present invention within the scope of the accompanying claims and their equivalents. For example, one or more operations of a method may be combined or further broken apart.

### Alternative Embodiments

While embodiments have been described which would natively execute the instructions described herein, alternative embodiments of the invention may execute the instructions through an emulation layer running on a processor that executes a different instruction set (e.g., a processor that executes the MIPS instruction set of MIPS Technologies of Sunnyvale, Calif., a processor that executes the ARM instruction set of ARM Holdings of Sunnyvale, Calif.). Also, while the flow diagrams in the figures show a particular order of operations performed by certain embodiments of the invention, it should be understood that such order is exemplary (e.g., alternative embodiments may perform the operations in a different order, combine certain operations, overlap certain operations, etc.).

In the description above, for the purposes of explanation, numerous specific details have been set forth in order to provide a thorough understanding of the embodiments of the invention. It will be apparent however, to one skilled in the art, that one or more other embodiments may be practiced without some of these specific details. The particular embodiments described are not provided to limit the invention but to illustrate embodiments of the invention. The scope of the invention is not to be determined by the specific examples provided above but only by the claims below.

1. A method of performing an instruction in a computer processor, comprising:
fetching the instruction, wherein the instruction includes a source operand and a destination operand;
decoding the fetched instruction;
executing the decoded by reversing the bit ordering for the source operand such that a least significant bit becomes a most significant bit;
storing a resulting bit-reversed data into the destination operand.

2. The method of claim 1, wherein the source operand is a register storing an unsigned integer.

3. The method of claim 1, wherein the source operand is a packed data operand comprising a plurality of data elements and wherein each of the plurality of data elements comprises a bit ordering and during execution each data element of the source operand is bit reversed.

4. The method of claim 3, wherein a number of data elements in the source operand is dependent on a data type and a width of the source operand.

5. The method of claim 3, wherein reversing the bit ordering for each data element of the source operand may be done in parallel or serially.

6. The method of claim 3, wherein the data elements are floating-point values.

7. The method of claim 3, wherein the data elements are integer values.

8. The method of claim 3, wherein the data elements are each one of an 8-bit, 16-bit, or 32-bit unsigned integers.

9. A non-transitory machine-readable medium having program code stored thereon which, when executed by a machine, causes the machine to perform the operations of:
fetching the instruction, wherein the instruction includes a source operand and a destination operand;
decoding the fetched instruction;
executing the decoded by reversing the bit ordering for the source operand such that a least significant bit becomes a most significant bit;
storing a resulting bit-reversed data into the destination operand.

10. The machine-readable medium of claim 9, wherein the source operand is a register storing an unsigned integer.

11. The machine-readable medium of claim 9, wherein the source operand is a packed data operand comprising a plurality of data elements and wherein each of the plurality of data elements comprises a bit ordering and during execution each data element of the source operand is bit reversed.

12. The machine-readable medium of claim 11, wherein a number of data elements in the source operand is dependent on a data type and a width of the source operand.

13. The machine-readable medium of claim 11, wherein reversing the bit ordering for each data element of the source operand may be done in parallel or serially.

14. The machine-readable medium of claim 11, wherein the data elements are floating-point values.

15. The machine-readable medium of claim 11, wherein the data elements are integer values.

16. The machine-readable medium of claim 11, wherein the data elements are each one of an 8-bit, 16-bit, or 32-bit unsigned integers.

17. An apparatus, comprising:
an instruction fetch circuitry to fetch an instruction, wherein the instruction includes a source operand and a destination operand;
a decoder circuitry to decode the fetched instruction;
an execution circuitry to:
execute the decoded by reversing the bit ordering for the source operand such that a least significant bit becomes a most significant bit; and
store a resulting bit-reversed data into the destination operand.

18. The apparatus of claim 17, wherein the source operand is a register storing an unsigned integer.

19. The apparatus of claim 17, wherein the source operand is a packed data operand comprising a plurality of data elements and wherein each of the plurality of data elements comprises a bit ordering and during execution each data element of the source operand is bit reversed.

20. The apparatus of claim 19, wherein a number of data elements in the source operand is dependent on a data type and a width of the source operand.

21. The apparatus of claim 19, wherein reversing the bit ordering for each data element of the source operand may be done in parallel or serially.

22. The apparatus of claim 19, wherein the data elements are floating-point values.

23. The apparatus of claim 19, wherein the data elements are integer values.

24. The apparatus of claim 19, wherein the data elements are each one of an 8-bit, 16-bit, or 32-bit unsigned integers.
